(19) United States
(12) Patent Application Publication
(10) Pub. No.: US 2026/0065536 A1
(43) Pub. Date: Mar. 5, 2026

(54) STREAMLINE VISUALIZATION METHOD AND APPARATUS FOR ANTI-ALIASING

(71) Applicant: Korea Electronics Technology Institute, Seongnam-si (KR)

(72) Inventors: In Pyo CHO, Yongin-si (KR); Sang Yub LEE, Yongin-si (KR); Jae Kyu LEE, Yongin-si (KR)

(21) Appl. No.: 19/216,040

(22) Filed: May 22, 2025

Related U.S. Application Data
(63) Continuation of application No. PCT/KR2025/002896, filed on Mar. 5, 2025.

(30) Foreign Application Priority Data
Sep. 5, 2024 (KR) 10-2024-0121180

(51) Int. Cl. G06T 11/20

(52) U.S. Cl. CPC G06T 11/23

(57) ABSTRACT

Proposed are a streamline visualization method and an apparatus for anti-aliasing. The method may include generating a first streamline by applying a Runge-Kutta method to vector field data. The method may also include calculating an equation of a first parametric curve based on a plurality of points included in the first streamline. The method may further include generating a second streamline along the first parametric curve, and selecting both endpoints of each vector group including consecutive vectors having similar directions in the second streamline. The method may further include calculating an equation of a second parametric curve based on coordinates of the essential points to generate a third streamline.

### CROSS REFERENCE TO RELATED APPLICATIONS

This is a continuation application of International Patent Application No. PCT/KR2025/002896 filed on Mar. 5, 2025, which claims priority to Korean patent application No. 10-2024-0121180 filed on Sep. 5, 2024, contents of each of which are incorporated herein by reference in their entireties.

### BACKGROUND

### Technical Field

The present disclosure relates to an image generation technique in the field of computer graphics. Specifically, the present disclosure relates to a technique for visualizing a streamline based on a vector field.

### Description of Related Technology

In the streamline visualization technology, the existing streamline visualization method (hereinafter referred to as the “existing technology”) employing only the Runge-Kutta method for solving ordinary differential equations may cause aliasing artifacts (staircasing effects) occurring in fine regions of the vector field, because vectors are connected linearly. The aliasing artifacts may distort visualization results to interfere with accurate interpretation of data, and in particularly in complex three-dimensional (3D) vector fields, may degrade the visual quality of streamlines.

### SUMMARY

One aspect is a streamline visualization method and apparatus that can generate an initial streamline within a 3D vector field based on a Runge-Kutta method for solving ordinary differential equations and additionally use Bezier curve equations to smoothly connect each vector to one another, thereby enhancing the visualization quality of the streamline while optimizing the use of computing resources by removing unnecessary vectors.

Aspects of the present disclosure are not limited to the those described herein, and other aspects not mentioned will be clearly understood by those skilled in the art from the description below.

Another aspect is a streamline visualization method may include: (a) receiving, by a streamline visualization apparatus, vector field data; (b) generating, by the stream visualization apparatus, a first streamline by applying a Runge-Kutta method to the vector field data; and (c) by the stream visualization apparatus, sampling a plurality of points included in the first streamline, calculating an equation of a first parametric curve based on coordinates of the plurality of points, and generating a second streamline along the first parametric curve.

In an embodiment of the present disclosure, the first parametric curve may be a Bezier curve.

In an embodiment of the present disclosure, the streamline visualization method may further include: (d) extracting vectors corresponding to the second streamline from the vector field data, grouping consecutive vectors having a directional difference within a predetermined error range from the extracted vectors to generate one or more vector groups, extracting line segments of the second streamline corresponding to the vector group, selecting both endpoints of each extracted line segment as essential points, calculating an equation of a second parametric curve based on coordinates of the essential points, and generating a third streamline along the second parametric curve.

In an embodiment of the present disclosure, the second parametric curve may be a Bezier curve.

In an embodiment of the present disclosure, the streamline visualization method may further include: (e) calculating an error rate of the third streamline based on an error of the third streamline relative to the first streamline; (f) comparing the error rate with a predetermined threshold value; and (g) adjusting the error range by applying a predetermined ratio to the error range when the error rate is greater than or equal to the threshold value.

In an embodiment of the present disclosure, the streamline visualization method may further include: (h) performing (d) extracting vectors by applying the error range adjusted in (g) adjusting the error range.

Another aspect is a streamline visualization apparatus that may include: a storage unit configured to store vector field data; a memory configured to store computer-readable instructions; and at least one processor configured to execute the instructions.

In an embodiment of the present disclosure, the at least one processor may be configured to, by executing the instructions, receive the vector field data from the storage unit, generate a first streamline by applying a Runge-Kutta method to the vector field data, sample a plurality of points included in the first streamline, calculate an equation of a first parametric curve based on coordinates for the plurality of points, and generate a second streamline along the first parametric curve.

In an embodiment of the present disclosure, the first parametric curve may be a Bezier curve.

In an embodiment of the present disclosure, the at least one processor may be configured to extract vectors corresponding to the second streamline from the vector field data, group consecutive vectors having a directional difference within a predetermined error range from the extracted vectors to generate one or more vector groups, extract line segments of the second streamline corresponding to the vector group, select both endpoints of each extracted line segment as essential points, calculate an equation of the second parametric curve based on coordinates of the essential points, and generate a third streamline along the second parametric curve.

In an embodiment of the present disclosure, the second parametric curve may be a Bezier curve.

In an embodiment of the present disclosure, the at least one processor may be configured to calculate an error rate of the third streamline based on an error of the third streamline relative to the first streamline, compare the error rate with a predetermined threshold value, and adjust the error range by applying a predetermined rate to the error range when the error rate is greater than or equal to the threshold value.

According to the present disclosure, by configuring a streamline using a Bezier curve, the curve can be expressed more smoothly and continuously. That is, the present disclosure has the effect of improving the visual quality of the streamline by minimizing the aliasing artifacts that the existing technology had, and in particular, has the effect of visualizing the shape of the streamline more accurately in a complex three-dimensional (3D) vector field.

In addition, according to the present disclosure, the amount of computation can be reduced by removing unnecessary vectors within a predetermined error range. Therefore, the present disclosure has the effect of optimizing the use of computing resources, thereby enabling faster and more efficient visualization.

In addition, according to the present disclosure, the error range can be flexibly set. Specifically, according to the present disclosure, the error range can be adjusted according to user or system requirements. Therefore, it is possible to generate streamlines optimized according to specific visual quality or performance requirements. For example, when high-quality visualization is required, an allowable error range may be set small to generate a precise streamline by using more vectors, whereas when the performance is prioritized, the allowable error range may be set large to reduce the number of vectors required for the streamline and thereby shorten the processing time. Therefore, the present disclosure can be applied to various fields of application. For example, the present disclosure can be utilized in various fields such as fluid dynamics, meteorology, and engineering applications.

In summary, the present disclosure provides high quality and efficiency in the visualization of various vector fields by combining Bezier curves and vector optimization techniques.

The effects that can be obtained from the present disclosure are not limited to the effects mentioned above, and other effects that are not mentioned can be clearly understood by those skilled in the art to which the present disclosure belongs from the description below.

### BRIEF DESCRIPTION OF THE DRAWINGS

FIG. 1 is a block diagram illustrating the configuration of a streamline visualization apparatus according to an embodiment of the present disclosure.

FIG. 2 is a flowchart illustrating a streamline visualization method according to an embodiment of the present disclosure.

FIGS. 3A to 3C are drawings illustrating comparison between two-dimensional (2D) curve processing effects of the existing technology and the present disclosure.

FIGS. 4A to 4C are drawings illustrating comparison between three-dimensional (3D) curve processing effects of the existing technology and the present disclosure.

### DETAILED DESCRIPTION

The existing technology constructs the streamlines using all vectors within the vector field, thereby resulting in unnecessary computational operations. In particular, when processing large vector fields, the amount of computation increases rapidly, which causes consumption of computing resources to excessively increase. This significantly reduces efficiency when processing real-time visualization or large data sets.

In addition, the existing technology has the problem of inefficient use of vectors. That is, the existing technology does not distinguish between vectors that convey important information and vectors that do not, thus generating inefficient streamlines including unnecessary vectors. This degrades the clarity of the visualization results and complicates user interpretation.

In addition, the existing technology has limitations in expressing smooth curves. Since the connections between vectors are linear in the existing technology, the streamlines may appear jagged rather than smoothly curved. Therefore, the existing technology has a problem that it has limitations in visualizing the natural flow of vector fields, and inaccurately represents streamlines in complex fields.

Meanwhile, since the existing technology follows fixed algorithms and procedures, it is difficult to flexibly adapt to various visualization requirements. In particular, there are limitations in balancing visual quality and performance, which limits the ability to provide visualization optimized for specific situations.

The present disclosure relates to a technique for visualizing streamlines based on vector fields. In particular, the present disclosure relates to a method of minimizing the aliasing artifacts and optimizing the use of computing resources by using a numerical solution of an ordinary differential equation and a Bezier curve.

The advantages and features of the present disclosure, and the methods for achieving them, will become clear with reference to the embodiments described in detail below together with the accompanying drawings. However, the present disclosure is not limited to the embodiments disclosed below, but may be implemented in various different forms, and these embodiments are provided only to make the disclosure of the present disclosure complete and to fully inform those skilled in the art of the scope of the invention, and the present disclosure is defined only by the scope of the claims. Terms used herein are used merely for describing specific embodiments and are not intended to limit the present disclosure. Singular expressions herein include plural expressions unless clearly defined otherwise in context. Throughout the application, it should be understood that the terms “include,” “have,” and the like represent the presence of features, numbers, steps, operations, components, parts, or combinations thereof described herein but do not preclude the presence or addition of one or more other features, numbers, steps, operations, components, parts, or combinations thereof.

Terms including ordinal numbers such as “second,” “first,” and the like may be used to describe various components, but the components are not limited by the terms. The terms are used for the sole purpose of distinguishing one component from others. For example, without departing from the scope of the present disclosure, a second component may be named a first component, and similarly, a first component may be named a second component.

When a component is described as being “connected” or “joined” to another component, it should be understood that the component may be directly connected or joined to the other component or still another component may be present therebetween. On the other hand, when a component is described as being “directly connected” or “directly joined” to another component, it should be understood that no other component is present therebetween. Other expressions that describe the relationship between components, such as “between” and “directly between” or “adjacent to” and “directly adjacent to,” should be interpreted similarly.

In this specification, vector field data refers to each point in the Euclidean space and a set of vectors corresponding thereto. In this specification, a streamline is configured by sequentially connecting some points included in the vector field data or points around them. Reducing the number of vectors (the number of vector samples) in a streamline means reducing the corresponding points. In addition, removing a point in a streamline means removing the corresponding vector.

In describing the present disclosure, if it is judged that a detailed description of related known technology may unnecessarily obscure the gist of the present disclosure, the detailed description thereof will be omitted.

Hereinafter, embodiments of the present disclosure will be described in detail with reference to the attached drawings. In describing the present disclosure, the same reference numbers will be used for the same means regardless of the drawing numbers in order to facilitate an overall understanding.

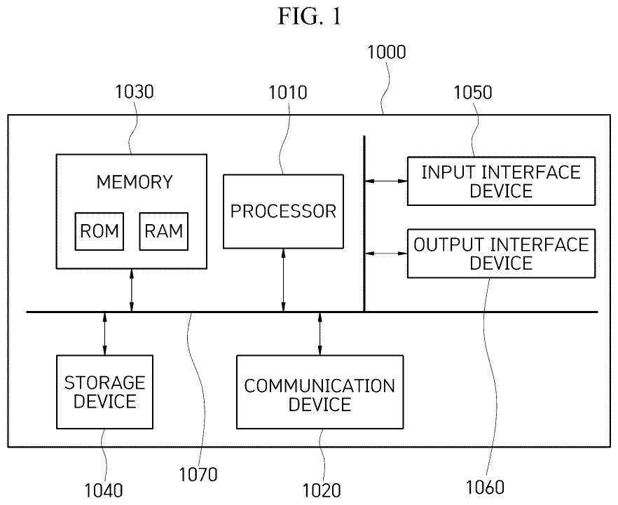

FIG. 1 is a block diagram illustrating the configuration of a streamline visualization apparatus according to an embodiment of the present disclosure.

A streamline visualization apparatus 1000 according to an embodiment of the present disclosure may visualize a streamline of two or more dimensions. The streamline visualization apparatus 1000 may perform a streamline visualization method according to the present disclosure. The streamline visualization apparatus 1000 may be implemented in the form of a computer system of FIG. 1.

Referring to FIG. 1, the streamline visualization apparatus 1000 may include at least one of at least one processor 1010, a memory 1030, an input interface unit 1050, an output interface unit 1060, and a storage unit 1040, which communicate through a bus 1070. The streamline visualization apparatus 1000 may also further include a communication unit 1020 coupled to a network.

The streamline visualization apparatus 1000 illustrated in FIG. 1 is merely an exemplary embodiment, and the components of the streamline visualization apparatus 1000 according to the present disclosure are not limited to the embodiment illustrated in FIG. 1, and may be added, modified, or deleted as needed.

The processor 1010 may be a central processing unit (CPU), or a semiconductor device that executes computer-readable instructions stored in the memory 1030 or the storage unit 1040. The memory 1030 and the storage unit 1040 may include various types of volatile or non-volatile storage media. For example, the memory 1030 may include a read-only memory (ROM) and a random access memory (RAM). In the embodiment of the present disclosure, the memory 1030 may be located inside or outside the processor 1010, and the memory 1030 may be connected to the processor 1010 through various means already known. The memory 1030 is a variety of volatile or non-volatile storage media, and for example, the memory 1030 may include ROM or RAM.

Accordingly, the embodiments of the present disclosure may be implemented as a computer-implemented method or as a non-transitory computer-readable recording medium having computer-executable instructions stored thereon. In an embodiment, the computer-readable instructions, when executed by the processor 1010, may perform a method according to at least one aspect of the present disclosure.

The communication unit 1020 may transmit or receive wired signals or wireless signals.

In addition, the streamline visualization method according to the embodiment of the present disclosure may be implemented in a form of program instructions which can be carried out via various computer means and stored in a computer-readable recording medium.

The computer-readable recording medium may include a program instruction, a data file and a data structure, or separately or cooperatively. The program instructions recorded on the computer-readable recording medium may be specially designed and structured for the embodiment of the present disclosure, or may be known and available to those skilled in the computer software arts. The computer-readable recording media may include a hardware device configured to store and execute program instructions. For example, the computer-readable recording media may be a magnetic media such as a hard disk, a floppy disk, and a magnetic tape, an optical media such as a CD-ROM, a DVD, a magneto-optical media such as a floptical disk, a ROM, a RAM, a flash memory, etc. The program instructions may include not only machine language codes such as those generated by a compiler, but also high-level language codes that can be executed by a computer through an interpreter, etc.

The processor 1010 receives vector field data stored in the memory 1030 or the storage unit 1040 by executing computer-readable instructions stored in the memory 1030 or the storage unit 1040, and generates a first streamline by applying the Runge-Kutta method to the vector field data.

The processor 1010 may be configured to sample a plurality of points included in the first streamline, calculate an equation of a first parametric curve based on coordinates of the plurality of points, and generate a second streamline along the first parametric curve.

The first parametric curve may be a Bezier curve.

The processor 1010 may be configured to extract vectors corresponding to the second streamline from the vector field data, group consecutive vectors having a directional difference within a predetermined error range from the extracted vectors to generate one or more vector groups, extract line segments of the second streamline corresponding to the vector group, select both endpoints of each extracted line segment as essential points, calculate an equation of a second parametric curve based on coordinates of the essential points, and generate a third streamline along the second parametric curve.

The second parametric curve may be a Bezier curve.

The processor 1010 may be configured to calculate an error rate of the third streamline based on an error of the third streamline relative to the first streamline, compare the error rate with a predetermined threshold value, and adjust the error range by applying a predetermined rate to the error range when the error rate is greater than or equal to the threshold value.

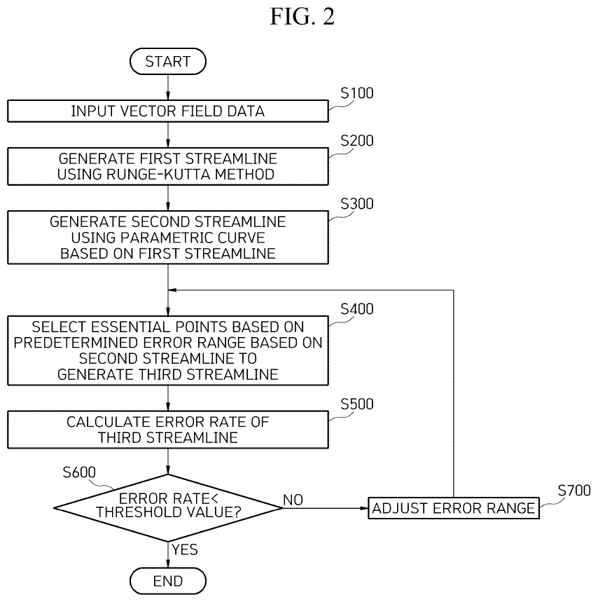

FIG. 2 is a flowchart illustrating a streamline visualization method according to an embodiment of the present disclosure.

Referring to FIG. 2, a streamline visualization method according to an embodiment of the present disclosure includes operations of S100 to S700. The streamline visualization method illustrated in FIG. 2 is merely an exemplary embodiment, and the operations of the streamline visualization method according to the present disclosure are not limited to the embodiment illustrated in FIG. 2, and may be added, modified, or deleted as needed.

For convenience of description, it is assumed that the streamline visualization method of FIG. 2 is performed by the streamline visualization apparatus 1000.

In operation S100, vector field data is received.

The streamline visualization apparatus 1000 receives vector field data from an external computational fluid dynamics (CFD) system. The vector field data may be two-dimensional (2D) or three-dimensional (3D) vector field data.

For example, the streamline visualization apparatus 1000 may receive vector field data through the communication unit 1020. The processor 1010 stores the vector field data in the memory 1030 or the storage unit 1040.

In operation S200, a first streamline is generated using the Runge-Kutta method. The processor 1010 reads the vector field data from the memory 1030 or the storage unit 1040. The processor 1010 generates the first streamline by applying the Runge-Kutta method to the vector field data.

In the present disclosure, the Runge-Kutta method for solving ordinary differential equations (referred to herein as the “Runge-Kutta method”) is used to generate a first streamline within a vector field. The Runge-Kutta method is a numerical technique widely used to generate streamlines by calculating the movement path between points included in the vector field data based on the direction of vectors. The processor 1010 forms the first streamline by moving each point included in the vector field data along the flow of the vector field using the Runge-Kutta method.

In operation S300, a second streamline is generated using a parametric curve based on the first streamline. The processor 1010 samples a plurality of points included in the first streamline, calculates an equation of the first parametric curve based on coordinates of the plurality of points, and generates a second streamline along the first parametric curve.

For example, the parametric curve used in the present disclosure may be any one of a Bezier curve, a spline, a Bezier spline, a Hermite spline, a Catmull-Rom spline, or a Cardinal spline. In the present disclosure, the types of the parametric curves are not limited to the above-described examples. However, for the convenience of description, this specification is described mainly in the case where the parametric curve is a Bezier curve.

After the first streamline is generated, the processor 1010 connects the points of the first streamline using a Bezier curve equation. Specifically, the processor 1010 collects the coordinates of the points of the first streamline and generates a Bezier curve based on the collected coordinates. Next, the processor 1010 generates a second streamline along the generated Bezier curve.

The Bezier curve that smoothly connects points can naturally represent the curvature of a streamline. Applying the Bezier curve to the generation of the streamlines enables smooth visualization of the streamline, thereby advantageously minimizing aliasing artifacts.

For example, the equation for a quadratic Bezier curve is as follows:

$$B ( t ) = {( 1 - t )}^{2} {P}_{0} + 2 ( 1 - t ) {tP}_{1} + {t}^{2} {P}_{2} ( 0 \leq t \leq 1 ) \qquad EQUATION 1$$

In Equation 1, t denotes a parameter, and P₀, P₁, and P₂ are control points that constitute a Bezier curve.

In operation S400, a third streamline is generated based on the second streamline by selecting essential points based on a predetermined error range.

The processor 1010 extracts positions of points constituting the second streamline and vectors corresponding to the positions of the points, from the vector field data. The number of extracted points and the number of vectors corresponding thereto may be determined according to a predetermined sampling count.

Next, the processor 1010 analyzes the directions of the extracted vectors to generate vector groups. Specifically, the processor 1010 groups consecutive vectors having a directional difference within a predetermined error range from the extracted vectors to generate one or more vector groups.

Next, the processor 1010 removes intermediate points among the points corresponding to the grouped vectors while leaving only the essential points. That is, the processor 1010 extracts line segments (a set of points) of the second streamline corresponding to the vector group, and selects both endpoints of each extracted line segment as the essential points.

Next, the processor 1010 calculates an equation of a second parametric curve based on coordinates of the selected essential points, and generates a third streamline along the second parametric curve.

The streamline visualization apparatus 1000 according to the present disclosure sets an error range to optimize the essential points constituting the streamline. The error range refers to a range within which vectors are regarded as having similar directions. For example, the error range may be represented by a cosine similarity value (e.g., 0.8 or higher, or 0.9 or higher). The error range may be set by input from an external device or a user.

The streamline visualization apparatus 1000 groups consecutive vectors having similar directions within the set error range in the vectors corresponding to the second streamline, and reduces the amount of computation and optimizes computing resources by removing unnecessary vectors from among the vectors included in each vector group. Through the above-described method, it is possible to improve the efficiency of streamline visualization while maintaining visualization quality.

In operations S500 to S700, the error range is adjusted according to aesthetic judgment or performance requirements. The error range applied to the generation of the third streamline in operation S400 may be adjusted through operations S500 to S700 based on aesthetic judgment or specific performance requirements. For example, when high-quality visualization is required, the error range can be adjusted small to increase the number of the essential points, and when the performance is prioritized, the error range can be adjusted large to decrease the number of the essential points.

In operations S500 and S600, the streamline visualization apparatus 1000 evaluates the visualization result (the third streamline) derived in operation S400 to determine whether a balance between quality and performance is achieved. In operation S700, when the visualization result does not meet the specific requirements, the streamline visualization apparatus 1000 adjusts the error range. The streamline visualization apparatus 1000 applies the adjusted error range and performs operation S400 again to generate an optimized streamline.

Hereinafter, each operation of operations S500 to S700 will be described in detail.

In operation S500, an error rate of the third streamline is calculated. The processor 1010 calculates the error rate of the third streamline based on the error of the third streamline relative to the first streamline.

When generating the third streamline in operation S400, since the curve is generated by reducing the number of vector samples (i.e., essential points), an error may occur relative to the first streamline. There may be various methods for calculating the error rate of the third streamline. For example, the processor 1010 may calculate the error rate of the third streamline according to Equations 2 to 5.

First, Equation 2 is an equation for calculating an error between streamlines.

$$E ( t ) = ‖ r ( t ) - {r}_{b} ( t ) ‖ \qquad EQUATION 2$$

In Equation 2, E(t) denotes an error between streamlines, r(t) denotes a third streamline (or the second parametric curve), and r_{b}(t) denotes a first streamline (a base curve).

Next, the processor 1010 calculates a sum of the errors. Equation 3 is an equation for calculating the sum of the errors.

$${E}_{total} = {\int }_{0}^{1} E ( t ) dt = {\int }_{0}^{1} ‖ r ( t ) - {r}_{b} ( t ) ‖ dt \qquad EQUATION 3$$

Next, the processor 1010 calculates a length of the third streamline. Equation 4 is an equation for calculating the length of the streamline.

$$L = {\int }_{0}^{1} ‖ {r}^{′} ( t ) ‖ dt \qquad EQUATION 4$$

Next, the processor 1010 may obtain the error rate of the third streamline by calculating the ratio of the total error to the length of the third streamline. Equation 5 represents the error rate of the third streamline expressed as a percentage.

$${E}_{percentage} = ( \frac{{E}_{total}}{L} ) \times 100 \% \qquad EQUATION 5$$

In operation S600, the error rate of the third streamline is compared with a threshold value. The threshold value can be set differently depending on specific requirements. For example, when high-quality visualization is required, the threshold value may be set low, and when high performance is required, the threshold value may be set high.

The processor 1010 may compare the error rate of the third streamline calculated in operation S500 with a predetermined threshold value. The processor 1010 may terminate the corresponding process when the error rate is less than the threshold value, and perform operation S700 when the error rate is greater than or equal to the threshold value.

In operation S700, the error range is adjusted. The processor 1010 adjusts the error range by applying a predetermined ratio to the error range applied to operation S400. For example, the processor 1010 may adjust the error range by multiplying the existing error range (cosine similarity 0.8 or higher) by 1.05 (increase by 5%) (adjusted error range: cosine similarity 0.84 or higher). As another example, the processor 1010 may adjust the error range based on a difference between the error rate and the threshold value. That is, when the error rate greatly exceeds the threshold value, the error range decreases more.

After operation S700, the processor 1010 may perform operation S400 again by applying the adjusted error range, thereby optimizing the streamline.

The above-described streamline visualization method has been described with reference to the flowcharts presented in the drawings. For simplicity, the method has been depicted and described as a series of blocks, but the present disclosure is not limited to the order of the blocks, and some blocks may occur in a different order or simultaneously with other blocks than depicted and described herein, and various other branches, flow paths, and orders of blocks may be implemented that achieve the same or similar results. Also, not all illustrated blocks may be required for implementation of the method described herein.

Meanwhile, in the description with reference to FIG. 2, each operation may be further divided into additional operations or combined into fewer operations, depending on the implementation of the present disclosure. In addition, some operations may be omitted as needed, and the order between the operations may be changed. In addition, even if other omitted content is present, the content of FIG. 1 may be applied to the content of FIG. 2. In addition, the content of FIG. 2 may be applied to the content of FIG. 1.

Hereinafter, results obtained by testing the streamline visualization method and apparatus according to the present disclosure will be described.

Table 1 shows the results obtained by testing the streamline visualization method and apparatus according to the present disclosure for one curve sample.

TABLE 1

| Number of vectors (100%) | Number of sampled vectors | Error rate |
|---|---|---|
| 5000 | 4000 (80% sampling) | 0.3% |
| | 3000 (60% sampling) | 0.6% |
| | 2000 (40% sampling) | 1.4% |
| | 1000 (20% sampling) | 1.6% |
| | 500 (10% sampling) | 2.3% |

When the number of vectors in the discrete vector field data is 5,000, even with 10% sampling, an error rate of 2.3% was observed.

In addition, the processing time required to extract vector data in a computational fluid dynamics (CFD) system varies depending on the number of vectors used, and the processing time required for extraction can be reduced by reducing the number of samples of used vectors. Table 2 shows the test environment to which the present disclosure is applied, and Table 3 shows the extraction processing time for the number of sampled vectors.

TABLE 2

| CPU | Intel Core i5-14th Gen 14400F, 10 cores, 4.7 GHz |
|---|---|
| Memory | DR5-5600 16 GB |
| Graphics card | RTX 3050 D6 6 GB |
| Storage device | SSD Crucial P3 M.2 NVMe |
| | 3000 MB/s |

TABLE 3

| Number of sampling vectors | Processing time |
|---|---|
| 5000 | 2 minutes 34 seconds |
| 4000 (80% sampling) | 1 minute 53 seconds |
| 3000 (60% sampling) | 1 minute 24 seconds |
| 2000 (40% sampling) | 57 seconds |
| 1000 (20% sampling) | 48 seconds |
| 500 (10% sampling) | 24 seconds |

When sampling 10% of the vectors, it can be seen that the processing time was approximately 15% of the time required to process 5,000 vectors.

Hereinafter, the anti-aliasing effect of the present disclosure will be described.

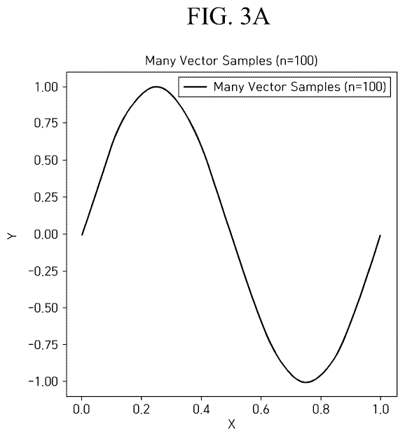

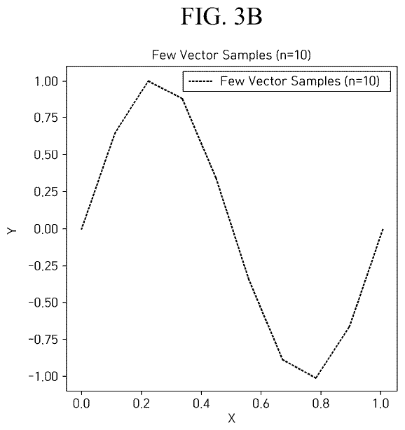

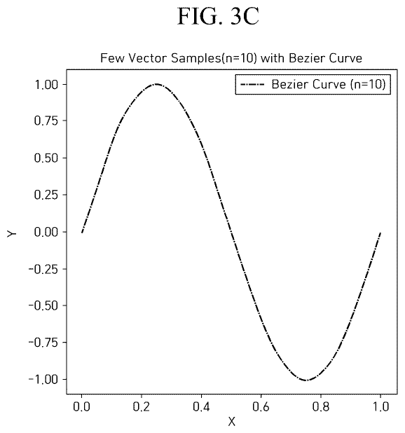

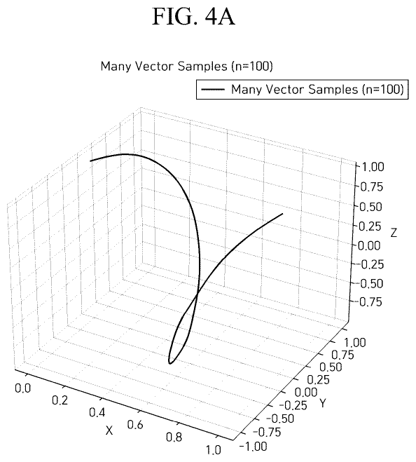

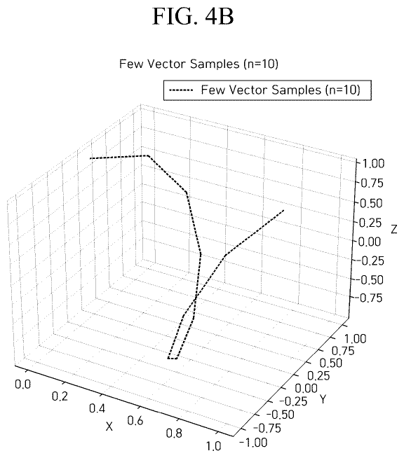

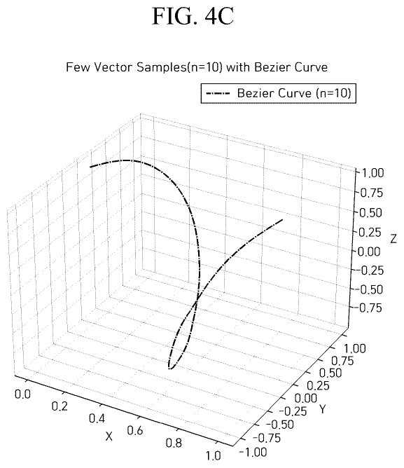

FIGS. 3A to 3C are drawings illustrating comparison between 2D curve processing effects of the existing technology and the present disclosure. FIGS. 4A to 4C are drawings illustrating comparison between 3D curve processing effects of the existing technology and the present disclosure.

FIGS. 3A and 4A illustrate streamlines generated by applying 100 vector samples based on the existing technology. FIGS. 3B and 4B illustrate streamlines generated by applying 10 vector samples based on the existing technology. FIGS. 3C and 4C illustrate streamlines according to the Bezier curve by applying 10 vector samples based on the present disclosure. When processing the Bezier curve using the method proposed in the present disclosure, it can be seen that aliasing artifacts do not occur visually even with a relatively small number of vectors, as shown in FIGS. 3C and 4C. In addition, according to the present disclosure, the error rate can be formed within the error rate (threshold value) desired by the user through accurate error rate calculation. That is, according to the present disclosure, the processing time and curve error rate desired by the user can be secured by automating the work to reach the error rate desired by the user.

Although the present disclosure has been described above with reference to preferred embodiments thereof, it will be understood by those skilled in the art that various modifications and changes may be made to the present disclosure without departing from the spirit and scope of the present disclosure as set forth in the claims below.

What is claimed is:

1. A streamline visualization method comprising:
receiving, by a streamline visualization apparatus, vector field data;
generating, by the stream visualization apparatus, a first streamline by applying a Runge-Kutta method to the vector field data;
sampling, by the stream visualization apparatus, a plurality of points included in the first streamline;
calculating, by the stream visualization apparatus, an equation of a first parametric curve based on coordinates of the plurality of points; and
generating, by the stream visualization apparatus, a second streamline along the first parametric curve.

2. The streamline visualization method of claim 1, wherein the first parametric curve is a Bezier curve.

3. The streamline visualization method of claim 1, further comprising:
extracting vectors corresponding to the second streamline from the vector field data;
grouping consecutive vectors having a directional difference within a predetermined error range from the extracted vectors to generate one or more vector groups;
extracting line segments of the second streamline corresponding to the vector group;
selecting both endpoints of each extracted line segment as essential points;
calculating an equation of a second parametric curve based on coordinates of the essential points; and
generating a third streamline along the second parametric curve.

4. The streamline visualization method of claim 3, further comprising:
calculating an error rate of the third streamline based on an error of the third streamline relative to the first streamline;
comparing the error rate with a predetermined threshold value; and
adjusting the error range by applying a predetermined ratio to the error range when the error rate is greater than or equal to the threshold value.

5. The streamline visualization method of claim 4, further comprising:
extracting the vectors by applying an adjusted error range.

6. A streamline visualization apparatus comprising:
a storage unit configured to store vector field data;
a memory configured to store computer-readable instructions; and
at least one processor configured to execute the instructions to:
read the vector field data from the storage unit,
generate a first streamline by applying a Runge-Kutta method to the vector field data,
sample a plurality of points included in the first streamline,
calculate an equation of a first parametric curve based on coordinates for the plurality of points, and
generate a second streamline along the first parametric curve.

7. The streamline visualization apparatus of claim 6, wherein the first parametric curve is a Bezier curve.

8. The streamline visualization apparatus of claim 6, wherein the at least one processor is configured to:
extract vectors corresponding to the second streamline from the vector field data, group consecutive vectors having a directional difference within a predetermined error range from the extracted vectors to generate one or more vector groups,
extract line segments of the second streamline corresponding to the vector group,
select both endpoints of each extracted line segment as essential points,
calculate an equation of the second parametric curve based on coordinates of the essential points, and
generate a third streamline along the second parametric curve.
